(19) United States
(12) Patent Application Publication
(10) Pub. No.: US 2006/0248004 A1
(43) Pub. Date: Nov. 2, 2006

(54) Method and system for administering a loan

(76) Inventor: Ronald Kenneth Griffiths, Manly (AU)

Correspondence Address: McCARTER & ENGLISH, LLP;Attn.: Angelica Brooks, CityPlace I, 185 Asylum Street, Hartford, CT, 06103, US

(21) Appl. No.: 11/397,094

(22) Filed: Apr. 4, 2006

(30) Foreign Application Priority Data
Apr. 5, 2005 (AU) 2005901665

(51) Int. Cl. G06Q 40/00

(52) U.S. Cl. 705/38

(57) ABSTRACT

A method for administering a loan includes the steps of debiting a first account in the name of a borrower with one or more payments of capital, calculating an interest amount based on an outstanding balance on the first account and debiting at least a portion of the interest amount to a second account, in a name other than the name of the borrower, such that no interest is debited to the first account. An electronic system facilitating the use of the above method for administering a loan.

### FIELD OF THE INVENTION

The present invention relates to financial products and in particular to a method and system for administering financial products. It has been developed primarily for use in administering a loan and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Many families prefer home ownership as opposed to renting a home in which to live. In most cases it is not possible to purchase a family home outright and it is necessary for a homeowner to borrow money from an appropriate financial institution, such as a bank, to finance the purchase. Typically, the homeowner will mortgage the house to the financial institution until the debt is repaid.

Due to the size of the debt, many mortgages are repaid over a period of twenty to thirty years. Often, the homeowner views these repayments as their primary form of investment, with the belief that the equity that builds up in their home over that period will fund their retirement.

While this scenario generally results in a large amount of equity being available to the homeowner at retirement, it is difficult to access this equity in an acceptable manner. Typically, the home does not produce an income as the homeowner still resides at the property. It may also be undesirable to sell the home as the excess cash and resulting investments could have an adverse impact on an existing pension arrangement. Therefore the homeowner is equity rich, but cash poor. That is, while they have sufficient equity available in their home to fund their retirement, they do not have easy access to the equity when it is required.

A partial solution to enable access to equity when required is a “reverse mortgage”. A reverse mortgage is a loan taken out by a homeowner that is secured by a mortgage over the home. The homeowner then draws equity from a loan account when required, however interest on the outstanding amount is capitalised for the duration of the loan (i.e. interest accrues on interest). The loan amount plus interest is then repaid once the home is ultimately sold.

As a result, reverse mortgages are viewed negatively due to “unconscionable lending” issues. There is also a risk of negative equity as the uncertain future value of the home may not be sufficient to cover the closing balance of the entire loan (that is, the capital amount plus interest). In addition, as interest is capitalised and there is no immediate cash flow from the loan, the financial institution may find it difficult to securitise the loan book on the secondary market.

Homeowners also often wish to leave as much equity to their beneficiaries as possible. This does not occur if capitalised interest has to be paid out of the sale proceeds of their home or out of their estate, prior to being distributed to their beneficiaries.

### DISCLOSURE OF THE INVENTION

It is an object of the present invention to overcome or ameliorate at least one of the disadvantages of the prior art, or to provide a useful alternative.

It is an object of the present invention in its preferred form to provide an improved method and system for administering a loan.

According to a first aspect of the invention there is provided a method for administering a loan including the steps of:
debiting a first account in the name of a borrower with one or more payments of capital;
calculating an interest amount based on an outstanding balance on said first account; and
debiting at least a portion of said interest amount to a second account in a name other than the name of said borrower, such that no interest is debited to said first account.

In some embodiments, the first account is administered by a first institution and the second account is administered by a second institution. Preferably, the payments of capital are periodic. Preferably also, the debiting of at least a portion of the interest amount is periodic.

In some embodiments at least a portion of the interest amount is debited to each of a plurality of second accounts, each of the plurality of second accounts being in a name other than the name of the borrower. Preferably, each of the plurality of second accounts is debited with an equal portion of the interest. In some embodiments each of the plurality of second accounts is debited with a predetermined portion of the interest.

Preferably, the interest is automatically debited to the second account. Preferably also, the second account is in the name of a relative of the borrower. In some embodiments, the first institution and the second institution are members of a common clearing system. Preferably, the clearing system is a national clearing system. More preferably, the clearing system is an international clearing system. Preferably, the interest is debited to the second account by electronic direct debit (EDD). Preferably also, the second account is selected from the group of a credit card account, a cheque account, a savings account or the like.

According to a second aspect of the invention there is provided a computer device for administering a loan, the device including:

one or more memory means for storing information relating to a first account in the name of a borrower and information relating to a second account in a name other than the name of said borrower; and

a processor disposed in communication with each of said memory means, said processor being configured to:

update said information relating to said first account with payments of capital;

calculate an interest amount based on an outstanding balance on said first account; and

cause at least a portion of said interest amount to be debited to said second account such that no interest is debited to said first account.

According to a third aspect of the invention there is provided an electronic system for administering a loan, the system including:

one or more memory means for storing information relating to a first account in the name of a borrower and information relating to a second account in a name other than the name of said borrower; and

a processor disposed in communication with each of said memory means, said processor being configured to:

update said information relating to said first account with payments of capital;

calculate an interest amount based on an outstanding balance on said first account; and

cause at least a portion of said interest amount to be debited to said second account such that no interest is debited to said first account.

Preferably, the first account is administered by a first institution and the second account is administered by a second institution. Preferably also, the payments of capital are periodic. Most preferably, the debiting of the at least a portion of the interest amount is periodic.

In some embodiments, the memory includes information relating to a plurality of second accounts each being in a name other than the name of the borrower and at least a portion of the interest amount is debited to each of the plurality of second accounts. Preferably, each of the plurality of second accounts is debited with an equal portion of the at least a portion of the interest amount. In some embodiments, the plurality of second accounts is debited with a predetermined portion of the at least a portion of the interest amount.

In some embodiments, the second account is in the name of a relative of the borrower.

Preferably, the first institution and the second institution are members of a common clearing system. More preferably, the clearing system is a national clearing system. In some embodiments, the clearing system is an international clearing system.

In some embodiments, the at least a portion of the interest amount is debited to the second account by electronic direct debit (EDD).

Preferably, the second account is selected from the group of a credit card account, a cheque account, a savings account or the like.

According to a fourth aspect of the invention there is provided an electronic system for debiting a financial account, the system including:

one or more memory means for storing information relating to the financial account and a loan account; and

a processor disposed in communication with each of said memory means, said processor being configured to:

calculate an interest amount based upon an outstanding amount in the loan account; and cause at least a portion of the interest amount to be debited to the financial account.

Preferably, none of the interest amount is debited to the loan account. Preferably also the financial account and the loan account are administered by separate financial institutions. In some embodiments the separate financial institutions are members of a common clearing system.

According to a fifth aspect of the invention there is provided a method for administering a loan including the steps of:
(a) debiting a first account in the name of a borrower with payments of capital;
(b) calculating an interest amount based on an outstanding balance on said first account; and
(c) debiting at least a portion of said interest amount to at least one second account in a name other than the name of said borrower.

In some embodiments, the method includes the steps of:
(b1) debiting the interest amount to the first account; and
(c1) crediting the at least a portion of the interest amount to the first account.

Preferably, the entire interest amount is debited to the at least one second account and the entire interest amount is credited to the first account such that no interest is compounded in the first account.

According to another aspect of the invention there is provided an electronic system for administering a loan, the system including:

one or more memory means for storing information relating to a first account in the name of a borrower and information relating to at least one second account in a name other than the name of said borrower; and

a processor disposed in communication with each of said memory means, said processor being configured to perform the steps of:

(a) updating said information relating to said first account with payments of capital;

(b) calculating an interest amount based on an outstanding balance on said first account; and

(c) causing at least a portion of said interest amount to be debited to said at least one second account.

In some embodiments, the processor is further configured to perform the steps of:

(b1) causing the interest amount to be debited to the first account; and

(c1) causing the at least a portion of the interest amount to be credited to the first account.

Preferably, the processor is configured to, in step (c), debit the entire interest amount to the at least one second account;

and, in step (c1), to credit the entire interest amount to the first account such that no interest is compounded in the first account.

According to another aspect, the invention provides the method of the proceeding aspects comprising a computer program adapted to run on a processing unit, the computer program being programmed to perform said first account debiting step, said interest calculating step and said interest debiting step.

According to another aspect, the invention provides a computer-readable medium encoded with the computer program of the above aspect.

According to yet another aspect, the invention provides the method and the computer program of the above two aspects, further comprising a signal carrying the computer program.

### BRIEF DESCRIPTION OF THE DRAWINGS

Preferred embodiments of the invention will now be described, by way of example only, with reference to the accompanying drawings in which:

FIG. 1 is a schematic diagram of an electronic system according the invention; and

FIG. 2 is a conceptual diagram showing the flow of capital and interest according to the invention;

FIG. 3 is a table showing a comparison of a prior art loan and a loan according to the invention;

FIG. 4 is a table showing the interest payable on a loan according to the invention;

FIG. 5 is a table showing the interest payable on a loan according to the invention;

FIG. 6 is a conceptual diagram showing the linking of a loan account and a plurality of third party accounts according to the invention;

FIG. 7 is a flowchart showing a process according to the invention;

FIG. 8 is a flowchart showing a process according to the invention;

FIG. 9 is a flowchart showing a process according to the invention;

FIG. 10 is a flowchart showing a process according to the invention;

FIG. 11 is a flowchart showing a process according to the invention;

FIG. 12 is a flowchart showing a process according to the invention; and

FIG. 13 is a flowchart showing a process according to the invention.

### PREFERRED EMBODIMENTS OF THE INVENTION

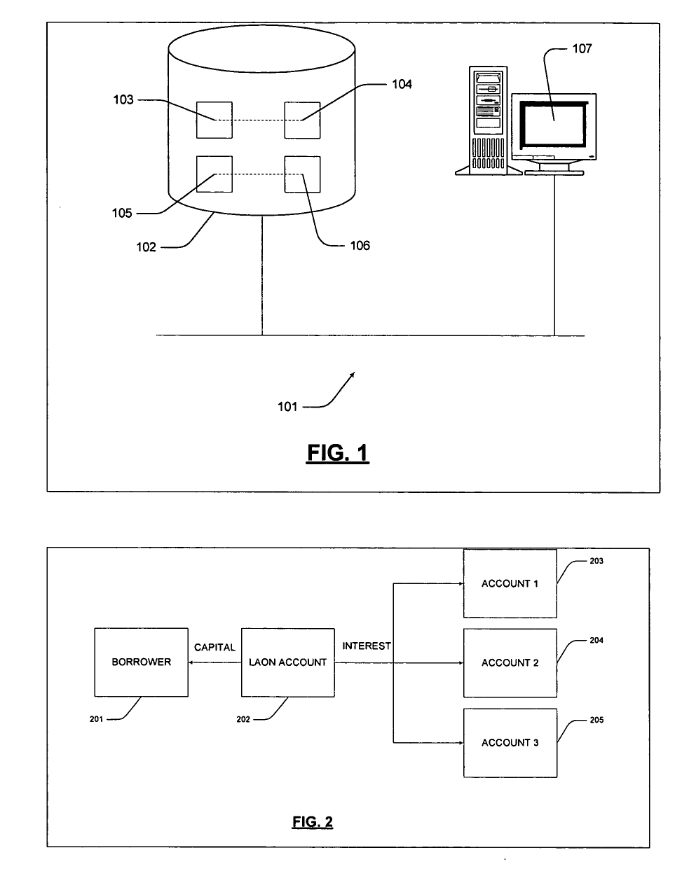

Referring to FIG. 1, there is shown an electronic system 101 for administering a loan provided by a financial institution. The system includes a memory in the form of a database 102, for storing information 103 relating to a first account 104 in the name of a borrower. The database 102 also stores information 105 relating to a second account 106 in a name other than the name of the borrower. That is, the respective owners of the first account and the second account are different. Of course, database 102 does not have to be a single database and could comprise two or more databases, which are in communication with each other and which can occupy the memory space of one or more carriers, such as memory chips.

A processor, in the form of a server 107 is disposed in communication with the database 102. The server is adapted to update the information 103 relating to the first account with one or more payments of capital to the borrower. This causes the account 104 to be debited with the appropriate amount of capital. The payments of capital are paid to the borrower either on demand when required by the borrower or periodically. That is, the borrower may require predetermined payments of capital to be made on a predetermined day of the month or year to meet known expenses. On demand payments are also available to the borrower to meet unexpected expenses. A combination of periodic and on demand payments can also be made to prevent excess capital from being drawn. As an example, if the borrower knows that they have $1,000 of fixed expenses but also have variable expenses, then that $1,000 can be periodically paid to cover the fixed expenses. On demand payments can then be made when the variable expenses arise thereby preventing the borrower from withdrawing money that is not needed.

If payments of capital have been made to the borrower, the account 104 is debited and interest will be payable on the outstanding balance of capital. The server 107 calculates an interest amount based on the outstanding balance on the first account 104 and causes the interest amount to be debited to one or more second accounts 106. In this way, no interest is debited to the first account 104. Hence, interest is only charged on the outstanding balance of capital and the capitalising or compounding of interest is avoided.

In some embodiments, the entire interest amount is initially debited to the first account 104. However at least a portion of the interest amount debited to the first account is then credited back to the first account, once it has been debited to one or more second accounts 106. In this, while interest may be debited to the first account, it is at least partially credited again, such that minimum or no interest is compounded in the first account.

Preferred embodiments will now be described with reference to specific examples of loans that are implemented using the system 101.

### EXAMPLE 1

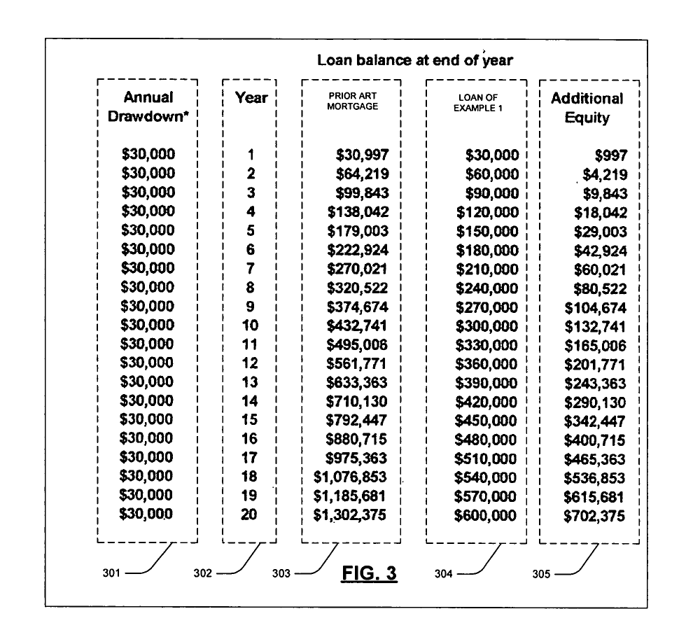

FIG. 2 is a conceptual diagram showing the flow of capital and interest in an embodiment of the invention where a borrower 201 opens a loan account 202, the loan account being in the name of the borrower. The loan is provided by a lending institution and is secured by the borrower's home (not shown). When the borrower requires capital, the capital amount is debited from the loan account and paid to the borrower. Capital is paid in a number of different manners, depending on the requirements of the borrower 201. In some instances capital is drawn from an Automatic Teller Machine (ATM) using an ATM card. In other instances a withdrawal is made from a human teller at a retail outlet of the financial institution. In some embodiments, the borrower pays expenses using a credit card and the amount of money spent on the credit card is debited to the loan account at the end of the relevant billing period. Capital can also be accessed using Internet or telephone banking. In some embodiments capital is paid to another financial account held in the name of the borrower.

In this example, the borrower's three children pay the interest amount that is due on the outstanding capital amount. In this case, the borrower is an individual and that individual owns the home, although it will be understood that the borrower could be multiple persons, or a corporation, that owns the home or the relevant asset to be mortgaged. Each of the three children provides their existing financial account details to the lending institution which debits their respective account with an agreed percentage of the interest due on the capital amount. The children's respective accounts (in their own name) are shown as 203, 204 and 205 and in this case child 1 has agreed to pay 50% of the interest amount, child 2 has agreed to pay 20% of the interest amount and child 3 has agreed to pay 30% of the interest amount. Accordingly, at the end of each predetermined billing period the interest amount on the entire outstanding capital amount is calculated and the appropriate proportion of the interest is debited by electronic direct debit (PDC) to each of the existing accounts 203, 204 and 205. The existing accounts are any one of a number of suitable accounts such as a credit card account, a cheque account, a savings account or the like. The Borrower 201 receives a monthly statement to ensure the validity of all capital transaction on the loan account 202. The children receive monthly statements showing their share of the interest charges being debited to their respective accounts 203, 204 and 205. When the homeowner passes away, the home can either be sold and each child repaid according to the interest charges they funded or, in some instances, the title of the home can be passed to the children should they wish to retain ownership of the house instead of selling it.

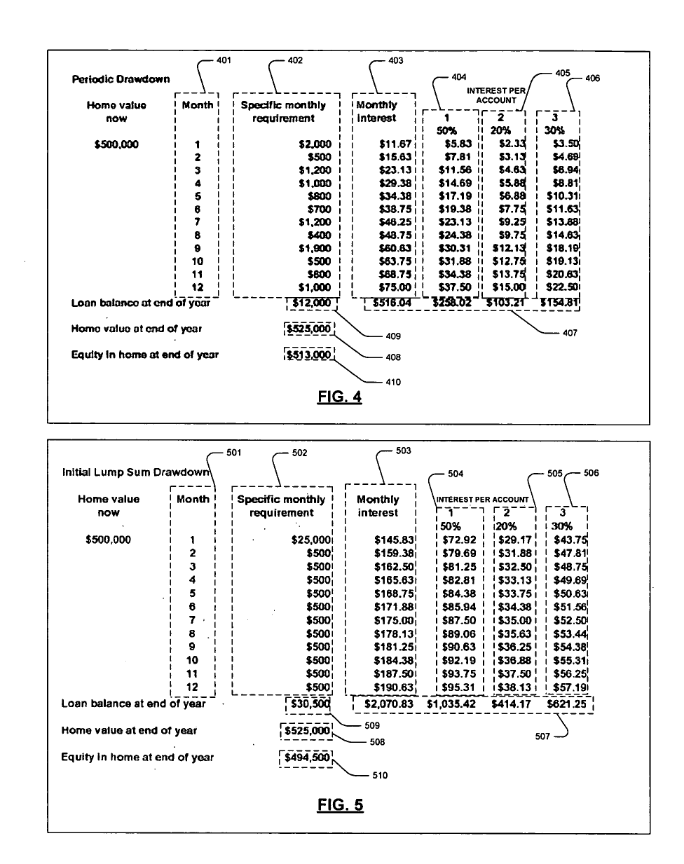

The table of FIG. 3 shows a comparison of the prior art loan and the loan described in example 1 above where the capital amount required by the borrower is $30,000 a year. Column 301 lists the recurring capital withdrawals for years 1 to 20 listed in column 302. Column 303 lists the outstanding balance of a loan in which the interest is compounded with capital (as in prior art reverse mortgage loans). Column 304 lists the outstanding capital amount of the loan account 202 in each of the years 1 to 20 where interest on the capital amount is charged to the accounts 203, 204 and 205 instead of being capitalised. Column 305 lists the additional equity available to the homeowner and/or their beneficiaries by using the loan of the preferred embodiment as opposed to the loan of the prior art, when the home is finally sold. The additional equity is the additional amount of money that would have otherwise been payable to settle the loan if the interest had been capitalised.

### EXAMPLE 2

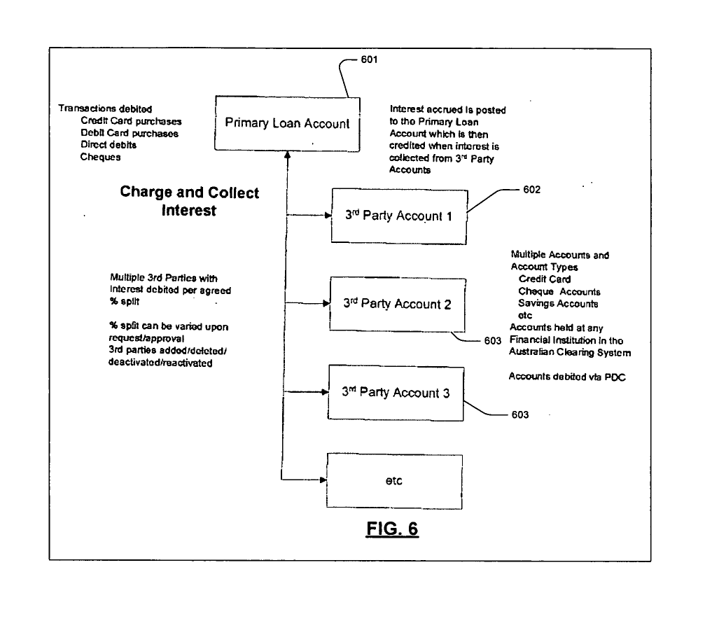

The table of FIG. 4 shows an example where a home worth $500,000 in month 1 is mortgaged with a loan according to an embodiment of the invention. In this example the borrower withdraws a different amount of capital each month to meet that month's expenses. Column 401 lists the months 1 to 12 which is the period of the loan over which this example is shown. Column 402 lists the capital withdrawals made over the months listed in column 401 and as can be seen, the monthly withdrawals vary according to the specific expenses of the borrower in that month. Column 403 lists the interest payable at the end of each of the months listed in 401. The interest payable in any particular month is payable not only on the capital withdrawn in that month, but rather the accumulated capital withdrawn in all the previous months (in this example, no capital is repaid—if capital is repaid, the capital amount and corresponding interest is reduced accordingly).

In some embodiments, the interest amount is debited to a single account. In other embodiments, the interest amount is debited to a plurality of second accounts. The interest amount is debited either equally, in that each account is debited an equal portion of the interest amount, or in a predetermined manner such that a predetermined portion of interest amount is debited to each account.

In this example, the interest amount listed in column 403 is split amongst three accounts, accounts 1, 2 and 3 and the respective percentage charged to each of the accounts is 50%, 20% and 30%. The interest amount charged to each of the accounts 1, 2 and 3 in the respective month is listed in columns 404, 405 and 406. For example, the total interest due in month 1 is $11.67 of which 50% ($5.83) is debited to account 1, 20% ($2.33) is debited to account 2 and 30% ($3.50) is debited to account 3. Row 407 lists the totals of the columns 403, 404, 405 and 406 at the end of the 12 months.

Numeral 408 shows the value of the home at the end of the 12 months. It can be seen that the value of the home has increased from $500,000 to $525,000. The equity in the home is then calculated by subtracting the loan balance at the end of the 12 months 409, that is $12,000, from the current value at the end of the 12 months. Therefore the equity in the home, 410, is $513,000. It will be understood that the amount of equity in the home, 410, is more than it would have been if the interest charged were compounded.

### EXAMPLE 3

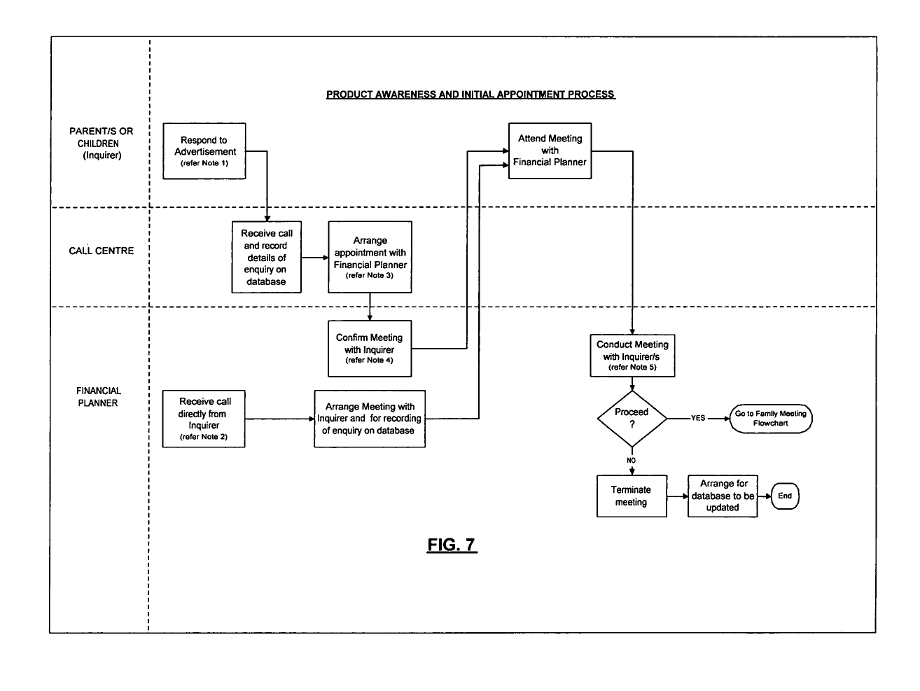

The table of FIG. 5 shows an example where a home worth $500,000 in month 1 is mortgaged with a loan according to an embodiment of the invention. In this example, the borrower withdraws a sum of $25,000 in month 1 and an amount of $500 in each of the next 11 months.

Column 501 lists the months 1 to 12 which is the period of the loan over which this example is shown. Column 502 lists the capital withdrawals made over the months listed in column 501. Column 503 lists the interest payable at the end of each of the months listed in 501. The interest payable in any particular month is payable not only on the capital withdrawn in that month, but rather the accumulated capital withdrawn in all the previous months.

In this example, the interest amount listed in column 503 is split amongst three accounts, accounts 1, 2 and 3 and the respective percentage charged to each of the accounts is 50%, 20% and 30%. The interest amount charged to each of the accounts 1, 2 and 3 in the respective month is listed in columns 504, 505 and 506. For example, the total interest due in month 1 is $145.83 of which 50% ($72.92) is debited to account 1, 20% ($29.17) is debited to account 2 and 30% ($43.75) is debited to account 3. Row 507 lists the totals of the columns 503, 504, 505 and 506 at the end of the 12 months.

Numeral 508 shows the value of the home at the end of the 12 months. It can be seen that the value of the home has increased from $500,000 to $525,000. The equity in the home is then calculated by subtracting the loan balance at the end of the 12 months 509, that is $30,500, from the current value at the end of the 12 months. Therefore the equity in the home, 510, is $494,500. It will be understood that the amount of equity in the home, 510, is more than it would have been if the interest charged were compounded.

In some embodiments, the first account (the loan account) is administered by a first institution and the second account from which interest is debited is administered by a second institution. This has the advantage that the person or persons that have agreed to pay the interest amount on the outstanding capital amount do not have to change their existing financial accounts and do have to open an additional account with the lending institution. In some embodiments there are a plurality of second accounts each being in a name other than the name of the borrower to which at least a portion of the interest is debited. In these embodiments a database such as that shown in FIG. 1 and denoted 102, stores information relating to the plurality of second accounts. When interest charges become due, a server such as server 107 uses the information relating to the plurality of seconds account to cause at least a portion of the interest amount to be debited to each of the plurality of second accounts.

Generally the debiting of both the capital the interest amount is periodic, which allows the borrower and the person or persons paying the interest amount to budget for their relevant expenses. In some embodiments, the second account is in the name of a relative of the borrower.

FIG. 6 is a conceptual diagram showing the linking of a loan account and a plurality of third party accounts 602, 603 and 604 to which interest on the outstanding capital amount on the loan account is debited. It will be understood by those skilled in the art that there can be any number of accounts to which interest is debited. These can be a mixture of third party accounts that are administered by a number of different financial institutions and accounts administered by the lending institution.

In order to facilitate the debiting of interest to third party account, the financial institutions are members of a common clearing system. The institutions with which accounts 602, 603 and 604 are held are members of the Australian Clearing System and the interest amount is debited to the accounts by electronic direct debit (PDC).

The accounts 602, 603 and 604 are any one of a credit card account, a cheque account, a savings account or the like.

As no interest is charged to the borrower's account, interest is only charged on the outstanding balance of capital and the capitalising or compounding of interest is avoided. That is, no interest is paid on interest. This is particularly advantageous when the loan has been provided to access equity from a home and where the homeowner is retired and the equity is being used to fund their retirement. It is also particularly advantageous in situations where the holder of the second account is in a cash-flow position allowing for payment of the interest amounts relatively quickly before the operation of compound interest can have a significant impact upon the amount held in the second account.

In some prior art systems homeowners typically access equity in their homes by means of a reverse mortgage that capitalises or compounds interest payments. In the preferred embodiment of the invention, the loan is secured against the homeowners' home and the interest payments (typically paid monthly) are shared amongst some or all of the homeowners' children. The interest is divided in an agreed and equitable basis and debited to the appropriate child's accounts. Instead of the children funding the principal cost of their parents (the homeowner or homeowners) retirement, they now only contribute to the interest cost. The homeowners are then able to utilise the equity in their home to substantially self-fund their lifestyle and retirement. In the preferred embodiment, there is no set term for the loan and the homeowners are not restricted to a fixed income stream. Capital can be utilised at any time to best suit the homeowners' cash flow requirements and lifestyle choices. As interest charges are met by the children, interest does not continue to accrue on the loan account as it would in the prior art. In the prior art, the equity in a home would accrue to the relevant financial institution due to the compounding of interest. With the preferred embodiment of the invention, the homeowner or their estate (in the event of the homeowners death) has a significant equity advantage when the home is sold and the loan repaid.

Therefore the preferred embodiment of the invention provides at least some of the following advantages:
it reduces the negative equity risk as the interest in not capitalised;
it allows for a higher Loan to Valuation Ratio (LVR) as the interest is not capitalised;
it provides regular coupon flow for the lending institution as interest is being paid monthly;
as interest is being paid instead of being capitalised, access to the secondary market in secured mortgage receivables is more easily available;
it allows homeowners to leave a maximum amount of equity to their beneficiaries upon their death;
it allows the homeowner more control over the equity position of the home; and
it ensures the homeowner and their beneficiaries gain the benefit of any appreciation in the value of the home.

The preferred embodiment allows interest to be automatically collected electronically from a nominated financial account. The nominated account can either be a credit card facility, a debit card facility, a cheque account, a savings account or any other suitable financial account. The account is held either with the lending institution or with a third party financial institution. Interest can be debited from accounts held with any financial institution so long as the relevant institution participates in a common clearing system. The clearing system can be a national clearing system such as the Australian Clearing System or an international clearing system.

While prior art banking computer systems are capable of distributing credit interest earned on an account held within their institution to one or multiple accounts held either within their institution or with third party institutions, they are unable to debit interest to multiple accounts or to third party accounts. They are also not enabled to allow collection of debit interest from multiple third party accounts on a predetermined percentage split of interest. The system 101 shown in FIG. 1 allows the debiting of interest to multiple accounts. In some embodiments the interest is debited on a predetermined percentage split of the interest amount and the accounts are provided by the financial institution or with a third part financial institution. In some embodiments the interest amount is debited to a plurality of accounts, some being provided by the lending institution and some being provided by a third party financial institution

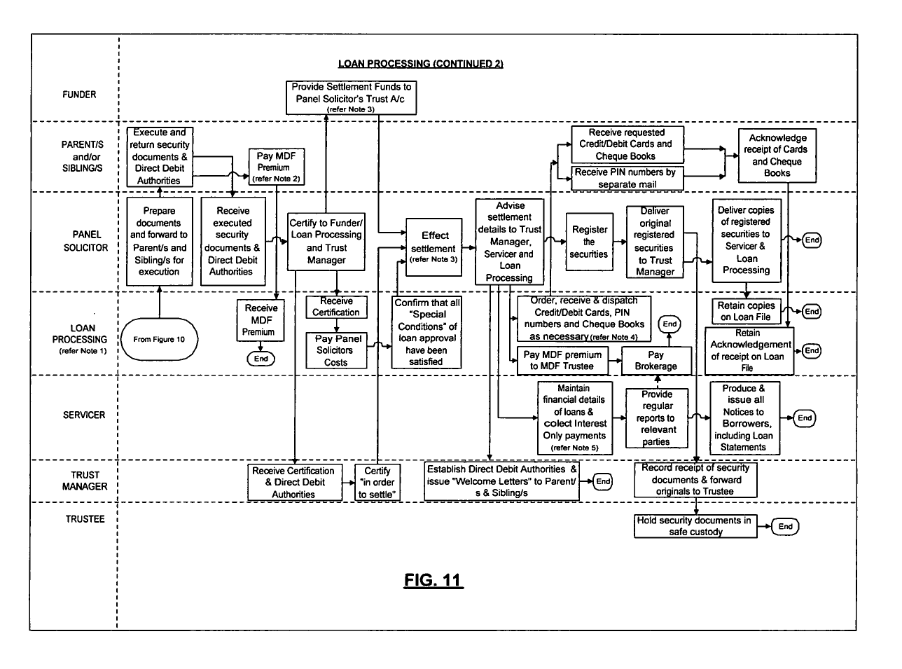

FIGS. 7 to 12 show several processes that are implemented in the preferred embodiment of the invention.

Turning now to FIG. 7, there is shown a process promoting product awareness and the setting up of an initial appointment between a financial institution and a borrower. The following notes are to be read in conjunction with FIG. 7:
Note 1. Advertisements may be in Newspapers, Radio, Magazines, Television or on a Web Site.
Note 2. Parent/s or children may contact a specific Financial Planner direct.
Note 3. Appointment is to be arranged with conveniently located Financial Planner or a Financial Planner of the caller's preference.
Note 4. Financial Planner confirms meeting with Inquirer either at Financial Planner's office or in Inquirer's home.
Note 5. Financial Planner meets with Inquirer in his/her office or at the home of one of the family members and explains the Loan specifics. Family members can either be present or link by electronic means or by proxy.

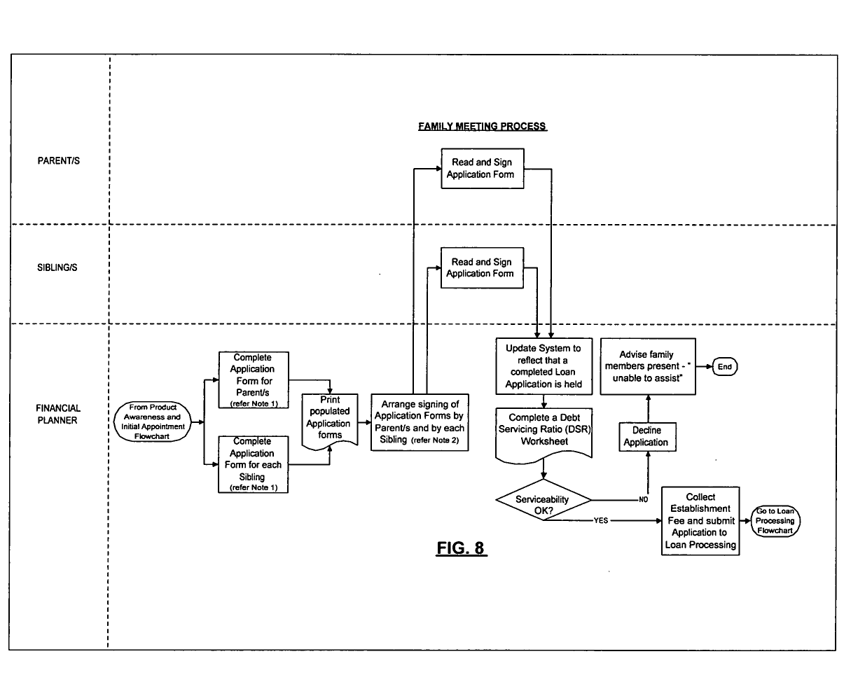

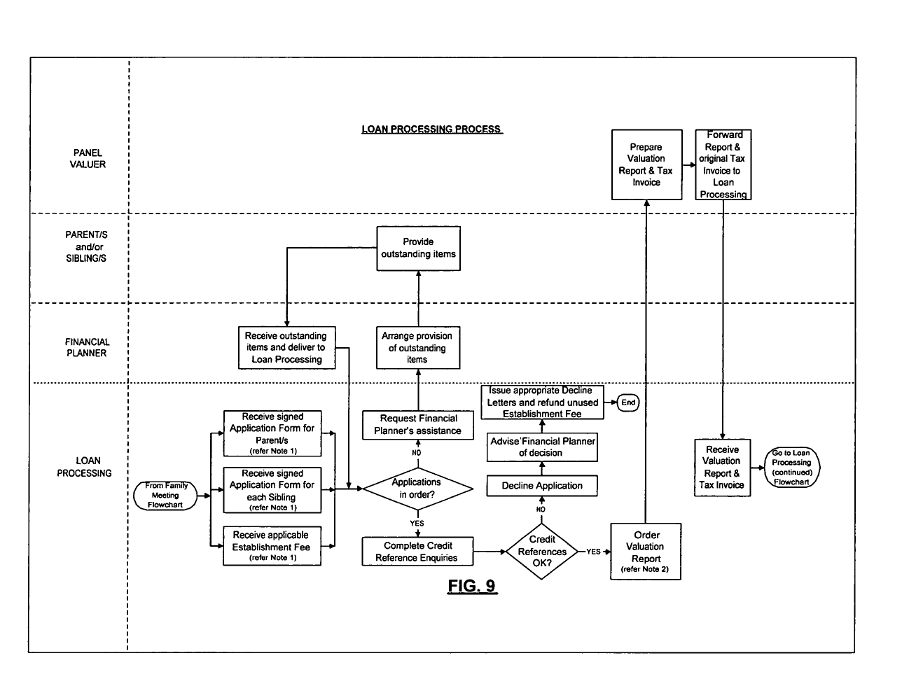

Turning now to FIG. 8, there is shown a process for running a family meeting. The following notes are to be read in conjunction with FIG. 8:
Note 1. Financial Planner completes the on-line Application Forms by recording all necessary details of the Parent/s and of each participating Sibling. Siblings will have agreed on the Credit Limit of the Loan for the Parent/s, each Sibling's nominated share of the monthly interest charge and their respective Credit Card limit for meeting monthly interest charges (on the Parent/s Discovery Succession Loan) and for their general use. All these details are entered at this point.
Note 2. If any family member is not present to sign the required Application Form, a standard Application Form containing the required Privacy Act consents is to be printed with known details and is to be sent to that person for their completion, signing and return before the application may proceed. Once the completed Application Form is returned, the System is to be updated with the balance of details provided.

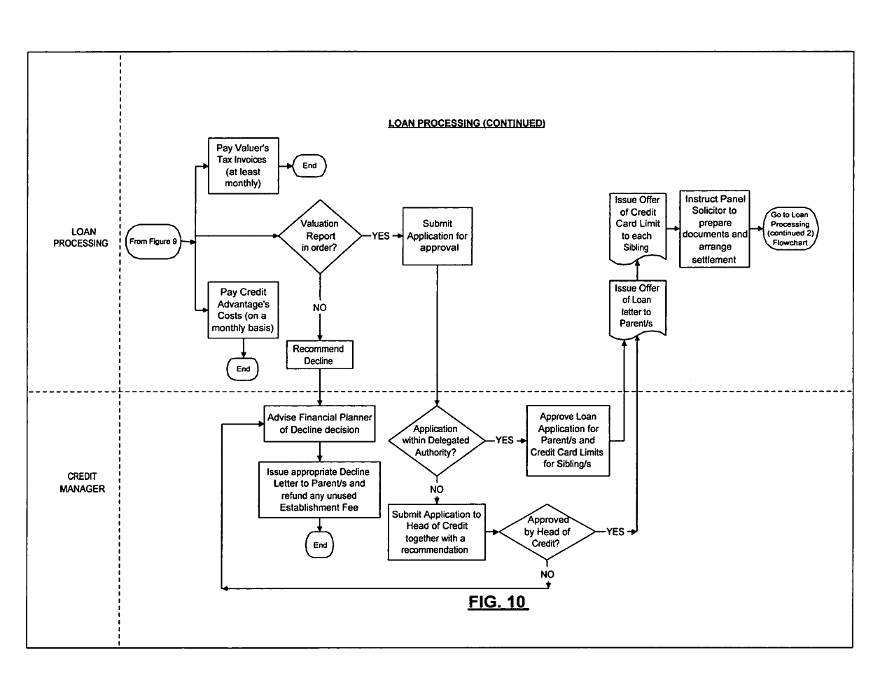

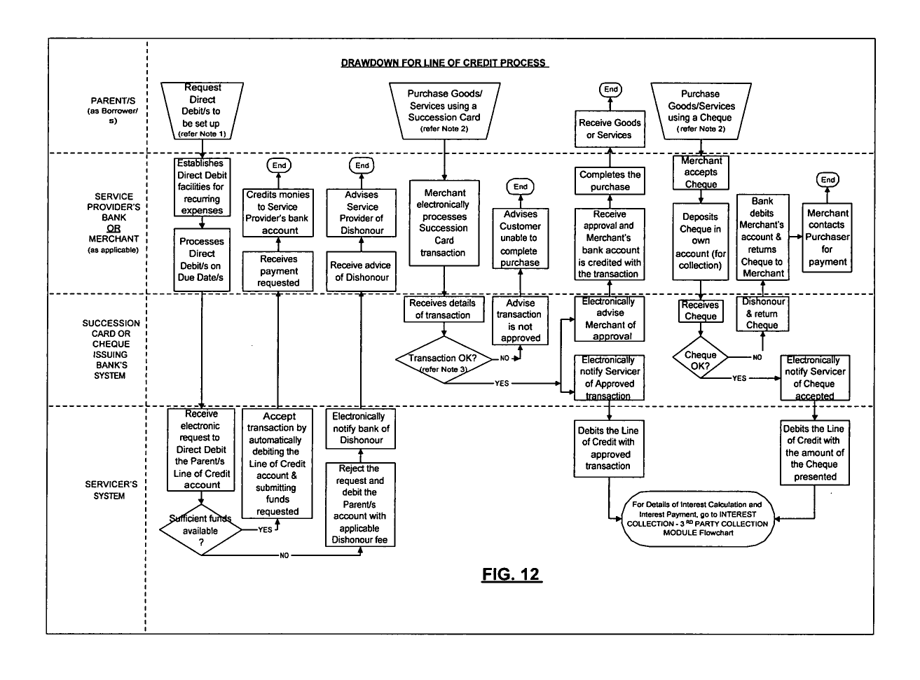

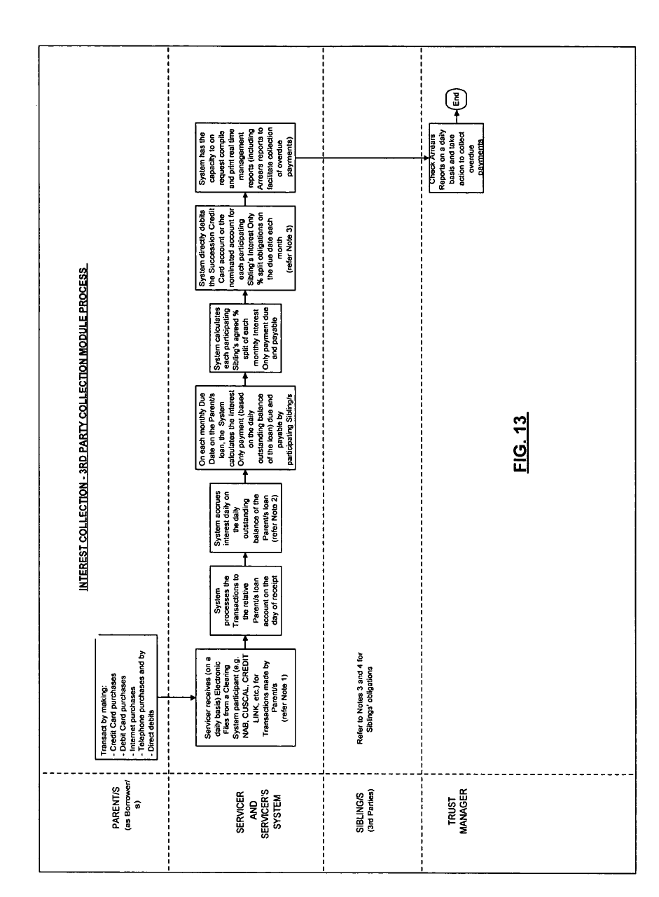

Turning now to FIGS. 9, 10 and 11, there is shown a process for processing a loan. The following notes are to be read in conjunction with FIG. 9:
Note 1. Loan Processing would have already received automatic notification from the System to expect these applications and the amount of any applicable Establishment Fee.
Note 2. Valuation Report requests are to be issued by Loan Processing only after the applicable Valuation Fee (payable as part of any Establishment Fee) has been paid or has been accounted for. Only valid Panel Valuer reports are acceptable for this programme.
   The following notes are to be read in conjunction with FIG. 11:
Note 1. All of the functions on this flowchart are “Head Office” functions.
Note 2. Parent/s and/or Sibling/s (as agreed between those parties) are required to pay a Mutual Discretionary Fund premium or its equivalent (Lender's Mortgage Insurance premium) prior to settlement to protect the Trustee (the Mortgagee for record purposes) in the event of default. This once only premium is requested in the Offer of Loan letter sent earlier in the process.
Note 3. If no settlement funds are required at these stages (e.g. to discharge any existing mortgages), refer to FIG. 12 for details of the drawdown process.
Note 4. The required Credit and Debit Cards and Cheque Books (requested in the Loan Application) are electronically ordered by Loan Processing accessing the Card and Cheque Book Issuer/Owner's system made available to Loan Processing for that specific purpose. The Card and Cheque Book Issuer produces and delivers the Cards and Cheque Books to Loan Processing for their further attention.
Note 5. For a detailed process of collecting Interest Only payments, refer to the FIG. 13.

Turning now to FIG. 12, there is shown a drawdown process for a line of credit. The following notes are to be read in conjunction with FIG. 12:
Note 1. If required, the Parent/s request the Supplier of Goods and/or Services to set up of Direct Debits to the Loan to cover recurring expenses such as telephone, Local Authority Rates, health insurance, home and contents insurance, and the like.
Note 2. Purchases can be made using a Credit or Debit Card, or with a Cheque. By using such a card, Parent/s can make purchases over the Internet or by way of the telephone. A Cheque Book will only be issued on the Loan if requested by the Parent/s.
Note 3. For an applicable Card or Cheque transaction to be acceptable, sufficient clear funds (after allowing for any un-presented authorised transactions) must be available on the Line of Credit facility at the time of the proposed transaction or at the time any Cheque is presented. Additionally, there must be no current event of default.
   Turning now to FIG. 13, there is shown process for a third party interest collection module. The following notes are to be read in conjunction with FIG. 13:
Note 1. The lending financial institution will need to have in place Settlement Obligations with the Clearing System participant used for its programme. This obligation is usually calculated by the selected Clearing System participant chosen and is generally equivalent to one or two days obligations in Cash and three days obligations supported by security.
Note 2. Interest accrues daily on the daily outstanding balance of the Parent/s loan and accrued interest is not capitalised but is due and payable monthly in arrears by participating Sibling/s.
Note 3. Multiple Siblings (3rd Parties) are allowed to meet their agreed % of each monthly “Interest Only” payment due on the Parent/s Discovery Succession Loan. Each Sibling's obligations are to be met from approved Credit Card Limits offered to each Sibling for such purposes and for general use or via a monthly Direct Debit from any of their nominated accounts at any Financial Institution in the Australian Clearing System that have Direct Debit capability. Each Sibling's % split of the monthly Interest Only payments can be varied upon request and is subject to approval by the lending institution. Additionally, Siblings can be added/deleted/deactivated/reactivated at the financial institutions discretion.
Note 4. Each participating Sibling is required to ensure there are sufficient funds in their nominated account for meeting agreed % split of Interest Only payments as they fall due on their Parent/s loan.

It will be appreciated that the illustrated embodiment of the invention provides an improved method and system for administering a loan.

Although the invention has been described with reference to specific examples, it will be appreciated by those skilled in that art that it may be embodied in many other forms. In particular, features of any one of the various described examples may be provided in any combination in any of the other described examples.

Furthermore, the functionality of various features of the preferred embodiment has been described as being performed by distinct devices. However, in other preferred embodiments, all or any combination of their functionality may instead be performed by multi-purpose integrated circuits or implemented in software executed by a processor. Particularly in such cases, the invention may additionally be embodied in a computer program or in a computer program carried by a data signal or stored on a data carrier.

The claims defining the invention are as follows:

1. A method for administering a loan including the steps of:
debiting a first account in the name of a borrower with one or more payments of capital;
calculating an interest amount based on an outstanding balance on said first account; and
debiting at least a portion of said interest amount to a second account in a name other than the name of said borrower, such that no interest is debited to said first account.

2. The method of claim 1, wherein the first account is administered by a first institution and the second account is administered by a second institution.

3. The method of claim 1, wherein the one or more payments are a plurality of periodic payments of capital.

4. The method of claim 1, wherein the debiting of at least a portion of the interest amount is periodic.

5. The method of claim 1, wherein at least a portion of the interest amount is debited to each of a plurality of second accounts, each of the plurality of second accounts being in a name other than the name of the borrower.

6. The method of claim 5, wherein each of the plurality of second accounts is debited with an equal portion of the interest.

7. The method of claim 5, wherein each of the plurality of second accounts is debited with a predetermined portion of the interest.

8. The method of claim 1, wherein the interest is automatically debited to the second account.

9. The method of claim 1, wherein the second account is in the name of a relative of the borrower.

10. The method of claim 2, wherein the first institution and the second institution are members of a common clearing system.

11. The method of claim 10, wherein the clearing system is a national clearing system.

12. The method of claim 10, wherein the clearing system is an international clearing system.

13. The method of claim 1, wherein the interest is debited to the second account by electronic direct debit (EDD).

14. The method of claim 1, wherein the second account is selected from the group of a credit card account, a cheque account, a savings account or the like.

15. A computer device for administering a loan, the device including:
one or more memory means for storing information relating to a first account in the name of a borrower and information relating to a second account in a name other than the name of said borrow; and
a processor disposed in communication with each of said memory means, said processor being configured to:
update said information relating to said first account with payments of capital;
calculate an interest amount based on an outstanding balance on said first account; and
cause at least a portion of said interest amount to be debited to said second account such that no interest is debited to said first account.

16. An electronic system for administering a loan, the system including:
one or more memory means for storing information relating to a first account in the name of a borrower and information relating to a second account in a name other than the name of said borrow; and
a processor disposed in communication with each of said memory means, said processor being configured to:
update said information relating to said first account with payments of capital;
calculate an interest amount based on an outstanding balance on said first account; and
cause at least a portion of said interest amount to be debited to said second account such that no interest is debited to said first account.

17. The electronic system of claim 16, wherein the first account is administered by a first institution and the second account is administered by a second institution.

18. The electronic system of claim 16, wherein the payments of capital are periodic.

19. The electronic system of claim 16, wherein the debiting of the at least a portion of the interest amount is periodic.

20. The electronic system of claim 16, wherein the memory includes information relating to a plurality of second accounts each being in a name other than the name of the borrower and at least a portion of the interest amount is debited to each of the plurality of second accounts.

21. The electronic system of claim 20, wherein each of the plurality of second accounts is debited with an equal portion of the at least a portion of the interest amount.

22. The electronic system of claim 20, wherein each of the plurality of second accounts is debited with a predetermined portion of the at least a portion of the interest amount.

23. The electronic system of claim 16, wherein the second account is in the name of a relative of the borrower.

24. The electronic system of claim 17, wherein the first institution and the second institution are members of a common clearing system.

25. The electronic system of claim 24, wherein the clearing system is a national clearing system.

26. The electronic system of claim 24, wherein the clearing system is an international clearing system.

27. The electronic system of claim 16, wherein the at least a portion of the interest amount is debited to the second account by electronic direct debit (EDD).

28. The electronic system of claim 16, wherein the second account is selected from the group of a credit card account, a cheque account, a savings account or the like.

29. An electronic system for debiting a financial account, the system including:
one or more memory means for storing information relating to the financial account and a loan account; and
a processor disposed in communication with each of said memory means, said processor being configured to:
calculate an interest amount based upon an outstanding amount in the loan account; and
cause at least a portion of the interest amount to be debited to the financial account.

30. The electronic system of claim 29, wherein none of the interest amount is debited to the loan account.

31. The electronic system of claim 29, wherein the financial account and the loan account are administered by separate financial institutions.

32. The electronic system of claim 31, wherein the separate financial institutions are members of a common clearing system.

33. A method for administering a loan including the steps of:
(a) debiting a first account in the name of a borrower with payments of capital;
(b) calculating an interest amount based on an outstanding balance on said first account; and
(c) debiting at least a portion of said interest amount to at least one second account in a name other than the name of said borrower.

34. The method of claim 33, wherein the method includes the steps of:
(b1) debiting the interest amount to the first account; and
(c1) crediting the at least a portion of the interest amount to the first account.

35. The method of claim 34, wherein in step (c) the entire interest amount is debited to the at least one second account and in step (c1) the entire interest amount is credited to the first account such that no interest is compounded in the first account.

36. An electronic system for administering a loan, the system including:
one or more memory means for storing information relating to a first account in the name of a borrower and information relating to at lest one second account in a name other than the name of said borrower; and
a processor disposed in communication with each of said memory means, said processor being configured to perform the steps of:
(a) updating said information relating to said first account with payments of capital;
(b) calculating an interest amount based on an outstanding balance on said first account; and
(c) causing at least a portion of said interest amount to be debited to said at least one second account.

37. The electronic system of claim 36, wherein the processor is further configured to perform the steps of:
(b1) causing the interest amount to be debited to the first account; and
(c1) causing the at least a portion of the interest amount to be credited to the first account.

38. The electronic system of claim 37, wherein the processor is configured to, in step (c), debit the entire interest amount to the at least one second account; and, in step (c1), to credit the entire interest amount to the first account, such that no interest is compounded in the first account.

39. A method according to any one of claim 1 further comprising a computer program adapted to run on a processing unit, the computer program being programmed to perform said first account debiting step, said interest calculating step and said interest debiting step.

40. A computer-readable medium encoded with the computer program of claim 39.

41. The method and the computer program of claim 39, further comprising a signal carrying the computer program.
